(19) United States
(12) Patent Application Publication
(10) Pub. No.: US 2026/0237919 A1
(43) Pub. Date: Aug. 13, 2026

(54) TERMINAL BLOCK

(71) Applicant: Yazaki Corporation, Tokyo (JP)

(72) Inventors: Yusuke TSUTAGAWA, Shizuoka (JP); Masato AKINO, Shizuoka (JP); Masatoshi YAMADA, Shizuoka (JP); Yasuhiro TANAKA, Shizuoka (JP); Sota ARAI, Shizuoka (JP)

(73) Assignee: Yazaki Corporation, Tokyo (JP)

(21) Appl. No.: 19/447,372

(22) Filed: Jan. 13, 2026

(30) Foreign Application Priority Data
Feb. 10, 2025 (JP) 2025-020013

(51) Int. Cl. H01R 9/24

(52) U.S. Cl. CPC H01R 9/24

(57) ABSTRACT

A terminal block includes a bus bar connected to a connection target, a housing provided with an insertion space portion through which the bus bar is inserted along an axial direction, and a packing inserted into the insertion space portion together with the bus bar and sealing an annular space between an outer surface of the bus bar and an inner surface of the insertion space portion, in which the bus bar includes a press-fit portion press-fitted and fixed to the housing on one end side in the axial direction with respect to the packing, and a packing holding portion extending along a plate thickness direction of the bus bar on the other end side in the axial direction with respect to the packing and holding the other end surface 30b of the packing in the axial direction.

### CROSS-REFERENCE TO RELATED APPLICATIONS

The present application claims priority to and incorporates by reference the entire contents of Japanese Patent Application No. 2025-020013 filed in Japan on February 10, 2025.

### BACKGROUND OF THE INVENTION

### 1. Field of the Invention

The present invention relates to a terminal block.

### 2. Description of the Related Art

As a technique related to a conventional terminal block, for example, JP 2022-161641 A discloses a terminal block including a base portion in which a through hole is formed, a bus bar to be inserted into the through hole of the base portion, and a sealing portion having heat resistance and being in liquid-tight contact with the base portion and the bus bar. The bus bar is provided with a constricted portion that regulates the movement of the partition seal member.

By the way, in the conventional terminal block described above, for example, the movement of the partition seal member with respect to the through hole along the axial direction can be prevented by the constricted portion, but there is a risk that the work of assembling the partition seal member with respect to the bus bar (constricted portion) takes time and effort.

### SUMMARY OF THE INVENTION

The present invention has been made in view of the above circumstances, and an object thereof is to provide a terminal block capable of appropriately preventing the movement of the packing along the axial direction with respect to the insertion space portion.

To achieve the above objection, a terminal block according to one aspect of the present invention includes a bus bar extending along an axial direction and connected to a connection target; and a housing provided with an insertion space portion through which the bus bar is inserted along the axial direction; and a packing inserted into the insertion space portion together with the bus bar and sealing an annular space between an outer surface of the bus bar and an inner surface of the insertion space portion, wherein the bus bar includes a press-fit portion press-fitted and fixed to the housing on one end side in the axial direction with respect to the packing, and a packing holding portion extending along a plate thickness direction of the bus bar on the other end side in the axial direction with respect to the packing and holding the other end surface in the axial direction of the packing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a terminal block according to an embodiment;

FIG. 2 is an exemplary exploded perspective view of the terminal block according to the embodiment;

FIG. 3 is an exemplary side view of the terminal block according to the embodiment;

FIG. 4 is an exemplary plan view of the terminal block according to the embodiment; and

FIG. 5 is an exemplary cross-sectional view of the terminal block according to the embodiment.

### DETAILED DESCRIPTION OF THE PREFERRED EMBODIMENTS

Hereinafter, an embodiment according to the present invention will be described in detail with reference to the drawings. Note that the present invention is not limited by the following embodiments. In addition, constituent elements in the following embodiments include those that can be easily replaced by those skilled in the art or those that are substantially the same. In the present specification, ordinal numbers are used only to distinguish components, members, sites, positions, directions, and the like, and do not indicate order or priority.

### Embodiment

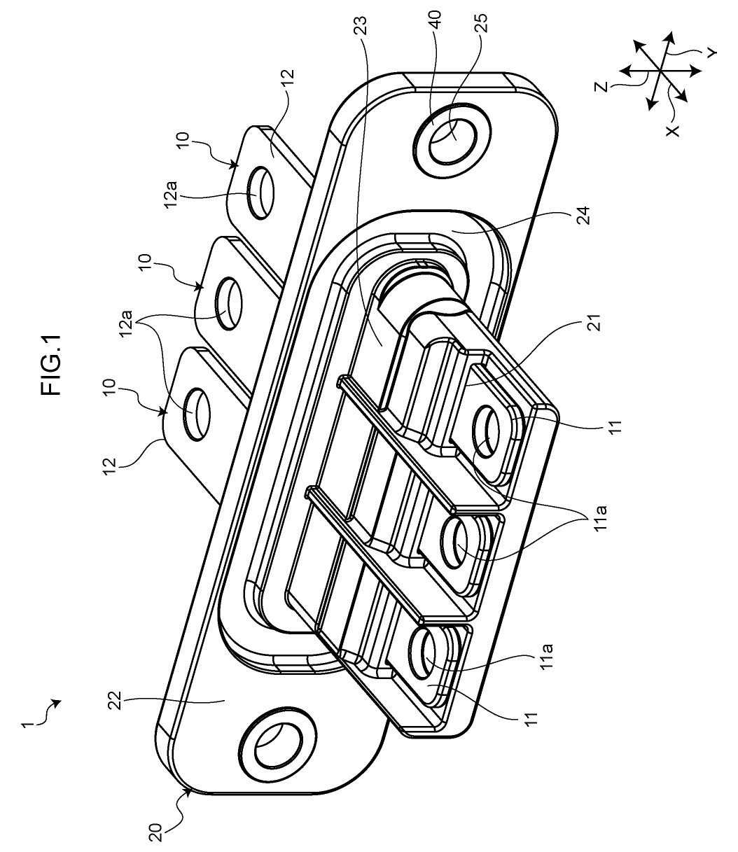

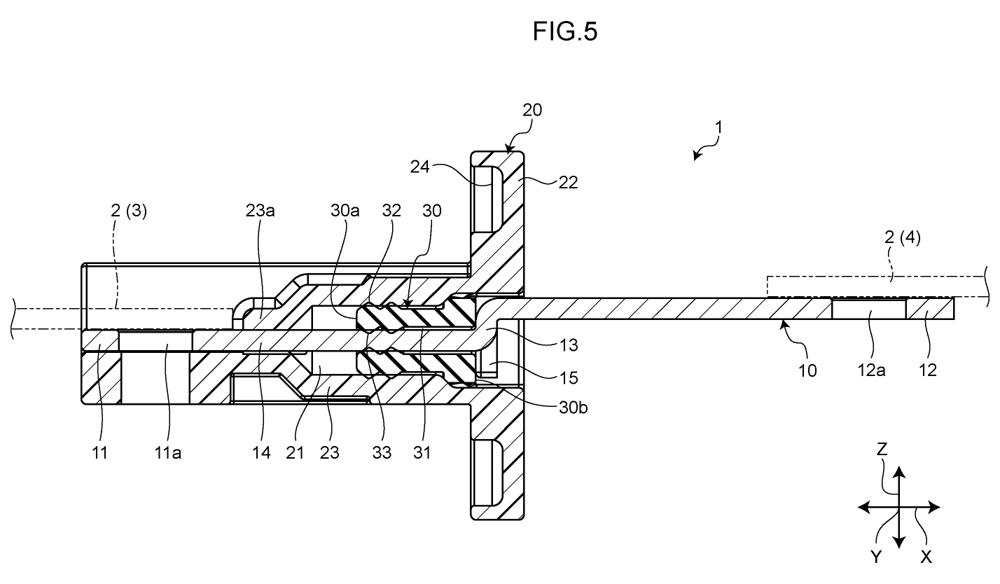

FIG. 1 is a perspective view of a terminal block 1 according to an embodiment. The terminal block 1 of the present embodiment illustrated in FIG. 1 is mounted on a vehicle such as an electric car or a hybrid car, for example, and relays electrical connection between a first device and a second device. The terminal block 1 of the present embodiment includes a bus bar 10, and an external terminal 3 (see FIG. 5) of the first device is electrically connected to a first connection portion 11 provided at one end of the bus bar 10. In addition, in the terminal block 1 of the present embodiment, an external terminal 4 of the second device is electrically connected to a second connection portion 12 provided at the other end of the bus bar 10. In the present embodiment, the external terminal 3 of the first device is an example of one of connection targets 2, and the external terminal 4 of the second device is an example of the other of the connection targets 2. The first device is, for example, one of a motor and an inverter, and the second device is, for example, the other of the motor and the inverter. Note that the terminal block 1 is not limited to this example, and may be used for, for example, relaying between the first device or the second device and the wiring member, relaying between the wiring member and the wiring member, and the like.

In the following description, among the first direction, the second direction, and the third direction that intersect each other, the first direction is referred to as an "axial direction X", the second direction is referred to as a "width direction Y", and the third direction is referred to as a "plate thickness direction Z". Here, the axial direction X, the width direction Y, and the plate thickness direction Z are substantially orthogonal to each other. Typically, the axial direction X corresponds to an extending direction of the bus bar 10, an insertion direction of the bus bar 10 with respect to the housing 20 (insertion space portion 21), a depth direction (front-rear direction) of the terminal block 1, and the like. The width direction Y typically corresponds to the width direction of the bus bar 10, the width direction (left-right direction) of the terminal block 1, and the like. The plate thickness direction Z typically corresponds to the thickness direction of the bus bar 10, the height direction (vertical direction) of the terminal block 1, and the like. In addition, each direction used in the following description will be described as a direction in a state where the terminal block 1 is mounted on a vehicle unless otherwise specified.

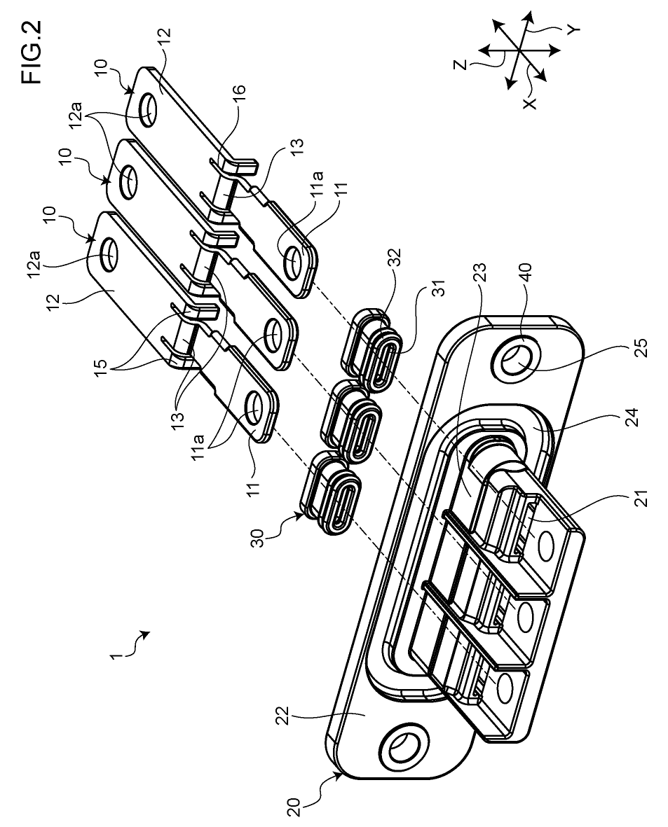

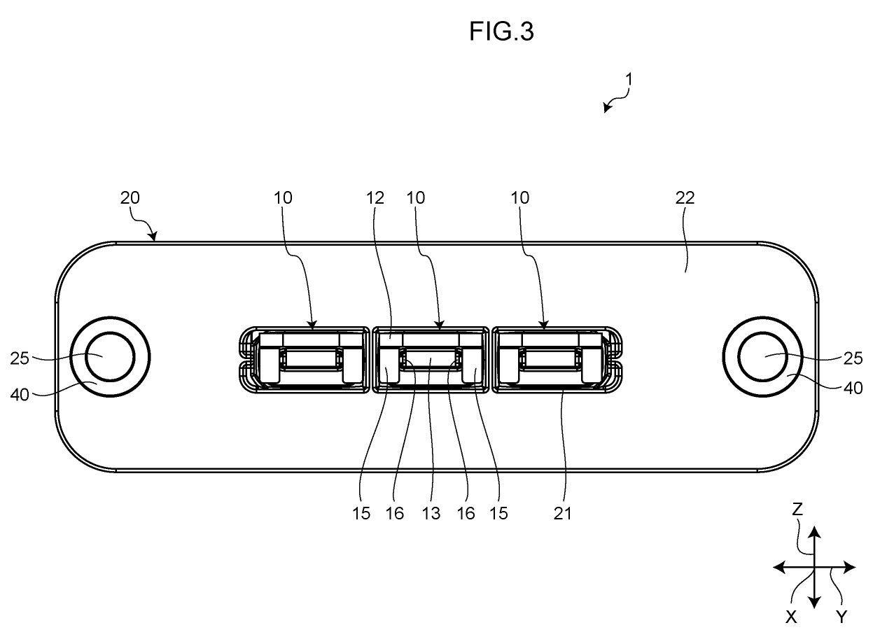

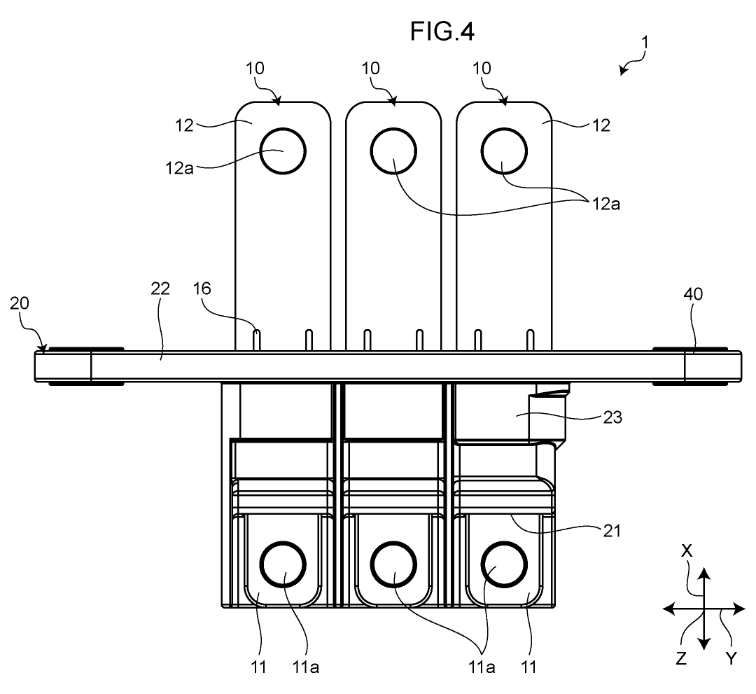

FIG. 2 is an exploded perspective view of the terminal block 1, FIG. 3 is a side view of the terminal block 1, and FIG. 4 is a plan view of the terminal block 1. As illustrated in FIGS. 2 to 4, the terminal block 1 includes, for example, the bus bar 10, the housing 20, a packing 30, and a collar 40. The bus bar 10 is a terminal fitting made of a conductive metal material, and is electrically connected to the external terminals 3 and 4 described above. In the present embodiment, three bus bars 10 are provided side by side along the width direction Y on the terminal block 1. The number of the bus bars 10 is not limited to this example, and for example, two or four or more bus bars 10 may be provided side by side along the width direction Y.

The bus bar 10 includes, for example, a first connection portion 11 provided at one end in the axial direction X, a second connection portion 12 provided at the other end in the axial direction X, an intermediate portion 13 provided between the first connection portion 11 and the second connection portion 12, and a packing holding portion 15 to be described later. The first connection portion 11, the second connection portion 12, the intermediate portion 13, and the packing holding portion 15 are integrally formed of a conductive metal material. That is, the bus bar 10 is formed such that each portion is three-dimensionally integrated into a crank shape by performing various processing such as bending processing on one sheet of metal according to the shape corresponding to each portion of the first connection portion 11, the second connection portion 12, the intermediate portion 13, and the packing holding portion 15.

The first connection portion 11 is a portion electrically and mechanically connected to the external terminal 3 of the first device described above. For example, the first connection portion 11 extends along the axial direction X and is positioned to be shifted from the second connection portion 12 along the plate thickness direction Z. The first connection portion 11 is provided with an attachment hole 11a to which a bolt or the like of a fastening member for fastening the bus bar 10 and the external terminal 3 is attached. The attachment hole 11a is a through hole penetrating the first connection portion 11 along the plate thickness direction Z, and is configured as, for example, a round hole having a larger diameter than the shaft portion of the bolt. As a result, the attachment hole 11a can absorb, for example, positional displacement of the bus bar 10 with respect to the external terminals 3 and 4 along the axial direction X.

The second connection portion 12 is a portion electrically and mechanically connected to the external terminal 4 of the second device described above. For example, the second connection portion 12 extends along the axial direction X and is positioned to be shifted from the first connection portion 11 along the plate thickness direction Z. The second connection portion 12 is provided with an attachment hole 12a to which a bolt or the like of a fastening member for fastening the bus bar 10 and the external terminal 4 is attached. The attachment hole 12a is a through hole penetrating the second connection portion 12 along the plate thickness direction Z, and is configured as, for example, a round hole having substantially the same diameter as the shaft portion of the bolt.

The intermediate portion 13 is a portion connected between the first connection portion 11 and the second connection portion 12, and extends along the plate thickness direction Z. The intermediate portion 13 includes, for example, a bent portion interposed between the first connection portion 11 and the second connection portion 12. The bent portion is bent at an angle of approximately 90° with respect to the first connection portion 11 and the second connection portion 12, for example. The intermediate portion 13 forms a step between the first connection portion 11 and the second connection portion 12. The thickness direction of the intermediate portion 13 is along the axial direction X intersecting the plate thickness direction Z of the first connection portion 11 and the second connection portion 12.

The housing 20 holds, for example, the bus bar 10, the packing 30, and the like, and is formed of an insulating synthetic resin material or the like. The housing 20 includes, for example, a housing main body 22 and a housing protrusion portion 23 protruding from the housing main body 22 along the axial direction X. In the present embodiment, the housing main body 22 is provided with attachment holes 25 to which fastening members such as bolts for fastening the housing 20 and an attachment object (not illustrated) are attached at both ends in the width direction Y. The attachment hole 25 is a through hole penetrating the housing main body 22 along the axial direction X. The attachment hole 25 is provided with, for example, a collar 40 that prevents contact between a bolt (metal) and the housing main body 22 (resin).

The housing main body 22 and the housing protrusion portion 23 are provided with an insertion space portion 21 through which the bus bar 10 is inserted along the axial direction X. The insertion space portion 21 is a through hole (opening) penetrating the housing main body 22 and the housing protrusion portion 23 along the axial direction X. In the present embodiment, the housing 20 is provided with three insertion space portions 21 corresponding to the bus bars 10, and these three insertion space portions 21 are partitioned from each other along the width direction Y.

The housing main body 22 is provided with a recess 24 for holding a seal member (not illustrated). The seal member seals between the housing 20 and an attachment object (not illustrated), and prevents entry of foreign matter such as moisture into the housing 20. The recess 24 is recessed from one end surface of the housing main body 22 in the axial direction X toward the other end side in the axial direction X, and is opened toward the one end side in the axial direction X. The recess 24 is provided, for example, at the peripheral edge of the housing protrusion portion 23, and is formed in a substantially elliptical annular shape along the outer shape of the seal member. In the housing 20, the housing main body 22 and the housing protrusion portion 23 are integrally formed.

The packing 30 prevents entry of foreign matter such as moisture into the housing 20. The packing 30 is formed of, for example, an elastically deformable member such as rubber or resin. For example, the packing 30 is formed in a substantially elliptical annular shape along the outer surface of the first connection portion 11 of the bus bar 10. That is, the packing 30 is provided with the insertion hole 31 through which the first connection portion 11 of the bus bar 10 is inserted along the axial direction X. The packing 30 is inserted into the insertion space portion 21 described above together with the bus bar 10, and seals an annular space between the outer surface of the bus bar 10 and the inner surface of the insertion space portion 21. In the present embodiment, three packings 30 are provided on the terminal block 1 side by side along the width direction Y corresponding to the bus bars 10. The packing 30 is also referred to as a terminal packing, a rubber plug, a bush, or the like.

The packing 30 is provided with a plurality of outer peripheral lip portions 32 and a plurality of inner peripheral lip portions 33 (see FIG. 5). The outer peripheral lip portion 32 is a pleated water stop portion formed in a substantially annular shape along the outer peripheral surface of the packing 30. In the present embodiment, for example, the packing 30 is provided with two outer peripheral lip portions 32 arranged in the axial direction X. In a state where the packing 30 is attached to the inside of the insertion space portion 21 of the housing 20 together with the bus bar 10, the outer peripheral lip portion 32 comes into contact with the inner surface of the insertion space portion 21 to stop water between the outer peripheral lip portion and the inner surface. The outer peripheral lip portion 32 is configured to be in close contact with the inner surface of the insertion space portion 21 by elastic deformation and seal the annular space between the inner surface and the outer peripheral surface of the packing 30.

The inner peripheral lip portion 33 is a pleated water stop portion formed in a substantially annular shape along the inner peripheral surface of the packing 30. In the present embodiment, for example, the packing 30 is provided with two inner peripheral lip portions 33 arranged in the axial direction X. The two inner peripheral lip portions 33 are positioned to overlap the two outer peripheral lip portions 32 along the plate thickness direction Z. In a state where the packing 30 is attached to the inside of the insertion space portion 21 of the housing 20 together with the bus bar 10, the inner peripheral lip portion 33 comes into contact with the outer surface of the first connection portion 11 of the bus bar 10 to stop water between the inner peripheral lip portion and the outer surface. The inner peripheral lip portion 33 is configured to be in close contact with the outer surface of the first connection portion 11 by elastic deformation and seal the annular space between the outer surface and the inner peripheral surface of the packing 30.

Here, in the present embodiment, the bus bar 10 is provided with a packing holding portion 15 that holds the other end surface 30b of the packing 30 in the axial direction X. For example, when the packing 30 is assembled to the insertion space portion 21, the packing holding portion 15 functions as a portion that pushes the packing 30 toward the one end side in the axial direction X (the back side of the insertion space portion 21), and also functions as a portion that prevents the movement (removal) of the packing 30 toward the other end side in the axial direction X with respect to the insertion space portion 21. In the present embodiment, a pair of packing holding portions 15 is provided on both sides of the intermediate portion 13 in the width direction Y. The pair of packing holding portions 15 extends along the plate thickness direction Z substantially along the intermediate portion 13 on the other end side in the axial direction X with respect to the packing 30.

In the present embodiment, a pair of slits 16 (see FIGS. 2 to 4) is provided between the intermediate portion 13 and the pair of packing holding portions 15. The pair of slits 16 is, for example, a notch-shaped opening portion for allowing elastic deformation of the intermediate portion 13 along the axial direction X. In the present embodiment, the pair of slits 16 extends along the plate thickness direction Z and the axial direction X so as to extend between the intermediate portion 13 and the second connection portion 12. In other words, the packing holding portion 15 includes a proximal end portion extending from the second connection portion 12 along the axial direction X and a distal end portion extending from an end portion of the proximal end portion opposite to the second connection portion 12 along the plate thickness direction Z. The packing holding portion 15 has a substantially L-shaped cross-sectional shape by a proximal end portion and a distal end portion.

FIG. 5 is a cross-sectional view of the terminal block 1. As illustrated in FIG. 5, the bus bar 10 is provided with a press-fit portion 14 that is press-fitted and fixed to the housing 20 on one end side in the axial direction X with respect to the packing 30. The press-fit portion 14 is provided, for example, at a substantially intermediate portion of the first connection portion 11 in the axial direction X, and is press-fitted and fixed to a distal end portion 23a of the housing protrusion portion 23. In the present embodiment, the insertion space portion 21 includes a small diameter portion into which the press-fit portion 14 of the bus bar 10 is inserted (press-fitted), and a large diameter portion into which the first connection portion 11 of the bus bar 10 and the packing 30 are inserted (press-fitted). The small diameter portion is located closer to one end side (the back side of the insertion space portion 21) in the axial direction X than the large diameter portion, and is formed in an opening shape substantially the same as or slightly smaller than the outer shape of the first connection portion 11. The large diameter portion has an opening width larger than that of the small diameter portion, and is configured to be substantially the same as or slightly smaller than the outer shape of the packing 30.

In the present embodiment, in a state where the bus bar 10 and the packing 30 are integrated with each other, the press-fit portion 14 is press-fitted into the small diameter portion of the insertion space portion 21, and the packing 30 is press-fitted into the large diameter portion of the insertion space portion 21 to be assembled to the housing 20. At this time, the packing holding portion 15 holds the other end surface 30b of the packing 30 in the axial direction X, whereby the movement (removal) of the packing 30 toward the other end side in the axial direction X with respect to the insertion space portion 21 is prevented.

As described above, in the terminal block 1 of the present embodiment, the bus bar 10 includes the press-fit portion 14 that is press-fitted and fixed to the housing 20 on one end side in the axial direction X with respect to the packing 30, and the packing holding portion 15 that extends along the plate thickness direction Z of the bus bar 10 on the other end side in the axial direction X with respect to the packing 30 and holds the other end surface 30b of the packing 30 in the axial direction X. With this configuration, in the terminal block 1, for example, the assemblability of the packing 30 with respect to the packing holding portion 15 can be improved, and furthermore, the movement (removal) of the packing 30 along the axial direction X can be prevented by the press-fit portion 14 and the packing holding portion 15 without using an assembling component such as a packing holder different from the bus bar 10. As a result, the terminal block 1 can appropriately prevent the movement of the packing 30 in the axial direction X with respect to the insertion space portion 21.

Further, in the terminal block 1 of the present embodiment, the bus bar 10 includes the first connection portion 11 provided at one end in the axial direction X and connected to one of the connection targets 2, the second connection portion 12 provided at the other end in the axial direction X and positioned to be shifted from the first connection portion 11 along the plate thickness direction Z and connected to the other of the connection targets 2, and the intermediate portion 13 provided between the first connection portion 11 and the second connection portion 12 and extending along the plate thickness direction Z, and the packing holding portion 15 is provided as a pair on both sides of the intermediate portion 13 in the width direction Y. With this configuration, in the terminal block 1, for example, since the other end surface 30b of the packing 30 in the axial direction X can be held by the pair of packing holding portions 15, the movement of the packing 30 with respect to the insertion space portion 21 in the axial direction X can be more appropriately prevented.

In addition, in the terminal block 1 of the present embodiment, a pair of slits 16 extending along the plate thickness direction Z and the axial direction X is provided between the intermediate portion 13 and the pair of packing holding portions 15. With this configuration, in the terminal block 1, for example, the packing holding portion 15 can be prevented from being elastically deformed together with the intermediate portion 13 by the pair of slits 16, and furthermore, the movement of the packing 30 with respect to the insertion space portion 21 along the axial direction X can be more appropriately prevented.

In the present embodiment, the case where the pair of packing holding portions 15 is provided on both sides of the intermediate portion 13 in the width direction Y has been exemplified, but the present invention is not limited to this example, and for example, an opening penetrating along the axial direction X may be provided at the central portion of the intermediate portion 13, and the packing holding portion 15 may be provided at the opening. In other words, the packing holding portion 15 may be provided between a pair of intermediate portions 13 provided at intervals along the width direction Y.

Although the embodiments of the present invention have been exemplified above, the above embodiments are merely examples, and are not intended to limit the scope of the invention. The above-described embodiments can be implemented in various other forms, and various omissions, substitutions, combinations, and changes can be made without departing from the gist of the invention. In addition, specifications (structure, type, direction, form, size, length, width, thickness, height, number, arrangement, position, material, and the like) of each configuration, shape, and the like can be appropriately changed and implemented.

The terminal block according to the present embodiment has an effect that the movement of the packing along the axial direction with respect to the insertion space portion can be appropriately prevented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar extending along an axial direction and connected to a connection target; and
a housing provided with an insertion space portion through which the bus bar is inserted along the axial direction; and
a packing inserted into the insertion space portion together with the bus bar and sealing an annular space between an outer surface of the bus bar and an inner surface of the insertion space portion, wherein
the bus bar includes a press-fit portion press-fitted and fixed to the housing on one end side in the axial direction with respect to the packing, and a packing holding portion extending along a plate thickness direction of the bus bar on the other end side in the axial direction with respect to the packing and holding the other end surface in the axial direction of the packing.

2. The terminal block according to claim 1, wherein
the bus bar includes a first connection portion provided at one end in the axial direction and connected to one of the connection targets, a second connection portion provided at the other end in the axial direction and positioned to be shifted from the first connection portion along the plate thickness direction and connected to the other of the connection targets, and an intermediate portion provided between the first connection portion and the second connection portion and extending along the plate thickness direction, and
the packing holding portion is provided as a pair on both sides of the intermediate portion in a width direction intersecting the axial direction and the plate thickness direction.

3. The terminal block according to claim 2, wherein
a pair of slits extending along the plate thickness direction and the axial direction is provided between the intermediate portion and the pair of packing holding portions.
